(19) United States
(12) Patent Application Publication
(10) Pub. No.: US 2005/0196542 A1
(43) Pub. Date: Sep. 8, 2005

(54) Plastic film instrument cluster overlays and method of making

(76) Inventor: Johnny G. Cooper, Grand Blanc, MI (US)

Correspondence Address: HARNESS, DICKEY & PIERCE, P.L.C., P.O. BOX 828, BLOOMFIELD HILLS, MI, 48303, US

(21) Appl. No.: 11/077,424

(22) Filed: Mar. 10, 2005

Related U.S. Application Data
(63) Continuation-in-part of application No. 10/365,066, filed on Feb. 12, 2003, now abandoned.

(51) Int. Cl. B05D 7/00

(52) U.S. Cl. 427/402

(57) ABSTRACT

A method of making an instrument cluster plastic film overlay for vehicle dash assemblies is provided. The method includes printing a digital image including at least one gauge scale indicator to a first surface of a plastic film using a digital printer. A scratch resistant coating is then applied to the first surface of the plastic film over top of the digital image. The plastic film is then cut to a shape of an instrument cluster display panel.

### CROSS-REFERENCE TO RELATED APPLICATIONS

This application is a continuation-in-part of U.S. Pat. application Ser. No. 10/365,066, filed on Feb. 12, 2003, the disclosure of which is incorporated herein by reference.

### FIELD OF THE INVENTION

The present invention relates to plastic film instrument cluster overlays and a method of making the plastic film instrument cluster overlay using a digital printing process.

### BACKGROUND OF THE INVENTION

Vehicle instrument clusters typically include gauges, such as speedometers, tachometers, and fuel and temperature gauges. These types of gauges commonly include a pointer body or needle coupled to a permanent magnet of the gauge assembly. The pointer body is oriented over top of a display panel that is typically made of a plastic substrate or film which is provided with gauge scale indicators for the speedometer, odometer, fuel gauge, oil gauge, battery voltage and temperature gauge, etc. In addition, additional non-gauge type indicia are also typically provided including turn signal indicia, bright headlight indicia, engine service indicia, cruise indicator indicia, and brake light indicator indicia. In addition, instrument cluster display panels often include a digital display for providing information to the driver regarding the odometer reading, a trip odometer, and other vehicle related information such as low fuel, low tire pressure, and low oil pressure warnings. In providing all this information on an instrument cluster overlay, including the use of various colors for different portions of the overlay, a labor intensive process of silk-screening, a plastic film has been utilized for making each of the instrument cluster display panel overlays.

Typically, each vehicle has its own unique instrument cluster display panel overlay, so special silkscreen templates are required for each overlay design. For each color that is used on an overlay, at least one template is required and at least one silkscreen process is performed for each template. It is not uncommon for an instrument cluster display panel overlay to have between 6 and 20 different colors and therefore, require between 6 and 20 different silkscreen printing processes; there are often multiple passes or layers for each color. Just preparing the silkscreen templates and setup for each different instrument cluster overlay design is extremely time intensive and expensive. In addition, between each silk-screening step with different colors, the applied ink is required to be dried before a subsequent silkscreen process can be performed. Often times, the plastic film overlay is heated in order to speed up the ink curing process in between each silkscreen stage. For a typical instrument cluster display panel overlay, the entire silkscreen process can take between 10 and 12 minutes for completion of a single overlay. In addition, because of the inherent drawbacks of the silk-screening process, it is difficult to obtain consistent production of silkscreen overlays that meet the required dimensional, color, and clarity specifications. Accordingly, it is desirable to provide a method of making an instrument cluster plastic film overlay for vehicle dash assemblies that is less labor intensive, less costly, and which produces more consistent quality with regard to dimensional, color, and clarity characteristics.

### SUMMARY OF THE INVENTION

The present invention provides a method of making an instrument cluster plastic film overlay for vehicle dash assemblies including printing a digital image onto a first surface of a plastic film using a digital printer. The digital image includes all of the gauge indicators and other indicia of a silkscreen instrument cluster overlay. However, by utilizing the digital image applied by a digital printer, the process for making the instrument cluster overlay can be reduced to less than 30 seconds per overlay. After the digital image is applied to the plastic film, a scratch resistant coating can be placed over top of the printed image in order to prevent the overlay from being scratched during handling prior to assembly into the dash assembly of a vehicle. The digital image can be applied to a sheet or roll of plastic film and can later be cut into the desired shape of an instrument cluster display panel, in addition to holes being punched out for accommodating the spindles of the gauges which are inserted therethrough. With the process of the present invention, improved quality can be obtained while reducing an amount of scrap material that is obtained. In addition, the process of the present invention utilizes a printer station, a clear coat station, a die cut station and inspection station that automates the entire process of manufacturing the instrument cluster display panel overlays.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a color drawing of an exemplary instrument cluster display panel overlay according to the principles of the present invention; and

FIG. 2 is a process flow diagram illustrating the method of making an instrument cluster plastic film overlay according to the principles of the present invention; and

FIG. 3 is a cross-sectional view of the instrument cluster overlay panel according to the principles of the present invention.

### DETAILED DESCRIPTION OF THE PREFERRED EMBODIMENTS

The following description of the preferred embodiment(s) is merely exemplary in nature and is in no way intended to limit the invention, its application, or uses.

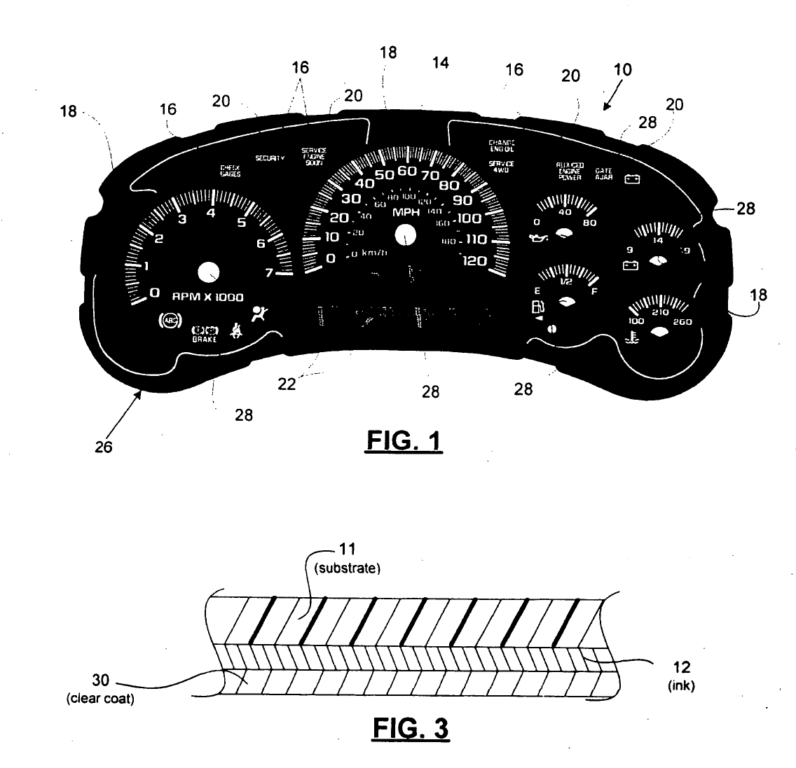

With reference to FIG. 1, an exemplary instrument cluster display panel overlay 10 is shown. The overlay 10 includes a plastic substrate 11 (best shown in FIG. 3) made from a polycarbonate film or other plastic material. An exemplary polycarbonate film, suitable for use with the process of the present invention is sold under the trade name LEXAN by General Electric Corporation; or MAKROFOL by Bayer Corporation. The overlay 10 also includes a digital image 12 printed thereon including a background color 14, such as the black illustrated in the exemplary embodiment (it should be noted that other colors could be utilized for the background color). Additionally, indicia are provided including text indicia 16, gauge indicator indicia 18, and icon or symbol type indicia 20. Furthermore, additional display windows 22 are provided through which digital text can be displayed by a digital display mechanism disposed below the windows 22. The outer perimeter 24 of the plastic film overlay is cut to a desired shape in order to properly cover the display panel of an instrument cluster. In addition, holes 28 are cut through the plastic film overlay 10 in order to receive the spindle of the gauges therethrough.

As can be seen from the color drawing of FIG. 1, the exemplary instrument cluster display panel overlay 10 includes six colors including black, white, green, blue, grey, and red. The digital image is reverse printed on the back surface of the plastic substrate so that the forward image is seen from the front surface of the substrate.

As seen in FIG. 3, a scratch resistant film 30, such as a clear coat, is applied on the back surface of the plastic overlay 10 in order to prevent the ink of the digital image from being scratched during handling of the plastic film overlay prior to installation in a vehicle. The scratch resistant coating can include, but is not limited to, a spray coating, a screen print coating or a laminate. It is preferable that the scratch resistant coating be a clear coat so that it does not interfere with the light that is emitted through the plastic film overlay.

The digital image that is applied to the plastic film overlay can be applied using a digital printer, such as the Hewlett Packard INDIGO printer, which is commercially available. In particular, the INDIGO printer line (Models S-2000, sheet fed; and WS-4000, roll fed) has been found to be suitable and provides approximately two to three digital images per minute, of this size and with the required number of passes, for proper ink opacity.

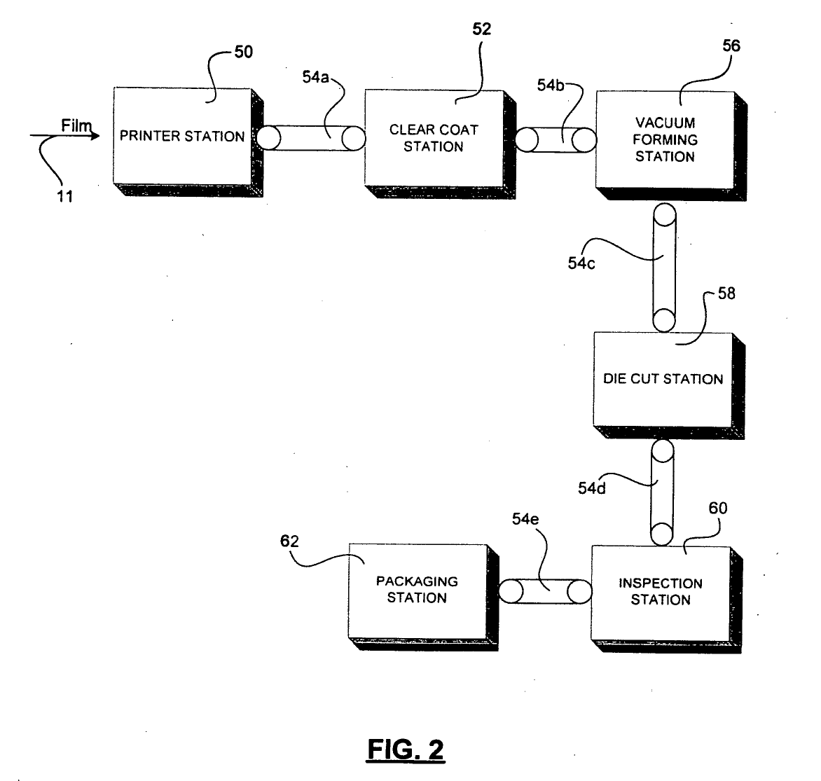

With reference to FIG. 2, the method of making the plastic film overlays, according to the principles of the present invention, will now be described. Initially, a digital image is programmed or loaded into the digital printer 50 and a plastic film substrate 11 either in sheet or roll form, is provided to the digital printer 50. The printer uses electromagnetic liquid ink applied to a drum in numerous passes to apply different color layers to the drum which is then applied to the plastic film. More than 16 passes of ink are preferably applied to the drum with the layers being disposed at different selected angular orientations. More preferably, as many as 30-32 passes of ink are applied to the drum which are then applied to the plastic film or substrate 11. Although conventional instrument cluster overlays include silk-screening applied to one surface of the plastic film, the present invention optionally includes images printed on both front and back surfaces of the plastic film.

After the digital image 12 is printed to the back surface of the plastic film or substrate 11, the film 11 is provided with a clear coat 30 overtop of the digital image 12 at the clear coat station 52. A conveyer system 54a can be provided for delivering the plastic film 11 to the clear coat station. An additional conveyer system 54b can then be utilized for delivering the plastic film from the clear coat station to an optional vacuum forming station 56 in which the plastic film is heated and formed into a predetermined shape using processes that are well known in the art. After the optional vacuum forming station 56, a conveyer 54c carries the plastic film to a die cut station 58 where the plastic film is cut to a predetermined shape and holes are punched for accommodating the drive spindles of the gauge assemblies. After the die cut station 58, the instrument cluster plastic film overlays 10 are delivered by a conveyer 54d to a digital inspection station 60 in which light which is passed through the plastic panel overlay is checked for dimensional color and clarity characteristics as compared to a set of characteristic standards. The optical scanning procedure uses known digital scanning techniques and compares the light characteristics to ensure the plastic film overlay falls within acceptable dimensional, color, and clarity characteristics as compared to an approved instrument cluster plastic film overlay. Plastic film overlays that do not need the required characteristics are rejected, and the instrument cluster plastic film overlays, which are acceptable, are passed onto a packaging station 62 via the conveyer system 54e.

There are few digital printers that possess the ability to print the color of white since most printers are designed for use in printing on white paper. As mentioned above, the Hewlett Packard INDIGO digital printer has been found to be acceptable for use in the present invention since the Indigo printer has the capability of printing white ink.

With the prior art method of printing instrument cluster plastic film overlays using the silk-screening process, as many as 40 percent of the plastic film panels are deemed to be unacceptable and are therefore rejected, leading to great inefficiency in the manufacturing process for making the plastic film overlays. With the method of the present invention, this reject ratio can be greatly reduced due to the high level of accuracy in maintaining dimensional, color, and clarity for hundreds and even thousands of repeated runs. The consistency and repeatability stems from the fact that the digital image file is never worn out. Thus, much like obtaining consistent sound quality with compact discs, the present invention maintains consistent image quality by using digital printing.

It is estimated that the present invention will save the automotive industry millions of dollars annually on the production of instrument cluster plastic film overlays by reducing the time and complexity of producing the plastic film overlays.

The description of the invention is merely exemplary in nature and, thus, variations that do not depart from the gist of the invention are intended to be within the scope of the invention. Such variations are not to be regarded as a departure from the spirit and scope of the invention.

1. A method of making an instrument cluster plastic film overlay for vehicle dash assemblies, comprising the steps of:
printing a digital image including at least one gauge scale indicator to a first surface of a plastic film using a digital printer that applies an electro-magnetic liquid ink to a drum using a predetermined number of passes that is then applied to the plastic film;
applying a scratch resistant coating to said first surface of said plastic film over top of said digital image; and
cutting said plastic film to a shape of an instrument cluster display panel.

2. The method according to claim 1, wherein said step of printing a digital image includes loading a digital image to a digital printer.

3. The method according to claim 1, further comprising the step of vacuum forming said plastic film after said step of printing said image.

4. The method according to claim 1, wherein said predetermined number of passes includes more than 16 passes.

5. The method according to claim 1, wherein said predetermined number of passes includes more than 30 passes.

6. The method according to claim 1, wherein said predetermined number of passes includes a plurality of passes applied at different angular orientations from one another.

7. The method according to claim 1, further comprising printing a second digital image to a second surface of said plastic film using said digital printer that applies said electromagnetic liquid ink to said drum using a predetermined number of passes that is then applied to the second surface of said plastic film.

8. A method of making an instrument cluster plastic film overlay for vehicle dash assemblies, comprising the steps of:
printing a digital image including at least one gauge scale indicator to a first surface of a plastic film using a digital printer;
applying a scratch resistant coating to said first surface of said plastic film over top of said digital image;
cutting said plastic film to a shape of an instrument cluster display panel; and
further comprising the step of digitally inspecting the printed digital image and comparing the digital inspection characteristics with approved digital characteristics to determine whether the digital image on said plastic film is within said approved digital characteristics.

9. The method according to claim 8, wherein said digital inspection characteristics include dimensional, color and clarity characteristics.
